(19) United States
(12) Patent Application Publication
(10) Pub. No.: US 2003/0214484 A1
(43) Pub. Date: Nov. 20, 2003

(54) Convertible mouse

(76) Inventor: Chad Christian Haywood, Van Nuys, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/152,047

(22) Filed: May 20, 2002

(51) Int. Cl. G09G 5/08

(52) U.S. Cl. 345/163

(57) ABSTRACT

A convertible mouse converts from a mouse mode to a joystick mode and vice versa. In mouse mode, the convertible mouse is a computer mouse with a recess positioned in a rear portion of the convertible mouse. The computer mouse has a sensor for deciphering mouse movement. A joystick handle is housed within the recess. The joystick handle is attached to a connecting member which is attached to the computer mouse. The joystick handle is operably positioned within the recess so that the joystick handle can be rotated from the recess when transforming the convertible mouse into joystick mode. A joystick button is positioned on the joystick handle for cooperation with a computer program.

### BACKGROUND OF THE INVENTION

1. Field of the Invention

The present invention relates in general to computer peripheral devices, and relates in particular to a computer mouse that is convertible into a joystick.

2. Description of the Related Art

Computing devices have recently evolved into faster, smaller, and more lightweight machines. For example, it is now possible to purchase a personal computer that weighs less than ten ounces with a 1 GHz processor. It was only a decade ago that personal computers had much slower processors and were much larger and heavier.

Unfortunately, computer peripheral devices have not developed at the rapid pace of their counterpart computing devices. Computer peripheral devices include accessories such as, for example, computer mice, joysticks, and keyboards. Significant size reductions have not been made to these computer peripheral devices to account for the size reductions in their counterpart devices. Another disadvantage of the present computer peripheral devices is the need to plug and unplug each device. The clunky size of the present computer peripheral devices and the need to unplug one device and plug in a second device make the use of peripheral devices especially difficult for laptop users, to whom a compact size is of the utmost importance.

Based on the foregoing, a need exists for a computer peripheral device that performs the function of multiple computer peripheral devices seen in the current marketplace. Computer users are always looking to use more compact and portable devices. Because the size of some computer peripheral devices such as, for example, a keyboard is often difficult to reduce, computer peripheral devices will have to perform the functions of other devices in order to save space. The computer gaming and peripheral industry is a large industry that will grow even larger with smaller and more space sensitive computer peripheral devices.

Many laptop users bring portable mice along with their laptops because the mouse pointer embedded within many modern day laptop computers is less comfortable to use than a computer mouse ordinarily used with PC's. Although many laptop users enjoy playing video games on their laptops, they find it too cumbersome to bring a clunky joystick with their laptops, especially if they are already transporting a computer mouse. Further, many PC users would like the ability to bring their favorite joystick to a remote location such as a friend's house. However, the size of most computer joysticks is too large to conveniently transport in a bag or carrying case. Therefore, a need exists for a computer peripheral device that is portable in addition to being multi-functional.

### SUMMARY OF THE INVENTION

One aspect of the present invention is a convertible mouse for use as a computer mouse and as a joystick. In accordance with this aspect, the convertible mouse comprises a computer mouse. The computer mouse has a recess positioned in a rear portion of the convertible mouse. A sensor deciphers mouse movement. A joystick handle is housed within the recess of the rear portion of the convertible mouse. The joystick handle is attached to a connecting member which is attached to the computer mouse. Advantageously, the joystick handle is operably positioned within the recess so that the joystick handle can be elevated from the recess. Preferably, a joystick release button is also attached to the computer mouse. When activated, the joystick release button elevates the joystick handle from the recess. A joystick button is positioned on the joystick handle for cooperation with a computer program.

In particular embodiments, the convertible mouse further comprises a stabilization member for releasably mounting the convertible mouse to a surface. The stabilization member can be positioned in the rear portion of the convertible mouse. Preferably, a button positioned on the stabilization member can be activated in order to eject a suction cup. In another embodiment, a sensor determines if the joystick release button has been activated and transmits data to a microprocessor indicating that the convertible mouse is in a mouse mode or a joystick mode.

Another aspect of the present invention is a method of transforming a computer peripheral device from a mouse to a joystick. In accordance with this aspect, the method comprises providing a computer mouse. The computer mouse has a left button, a right button, and a palm resting surface. The method includes rotating the left button and the right button from a first position to a second position, thereby exposing a joystick handle. In particular embodiments, the method further comprises the step of transforming the computer peripheral device from the joystick to the mouse.

In yet another aspect of the present invention, there is a computer peripheral device. In accordance with this aspect, the computer peripheral device comprises a left button, a right button, a sensor for deciphering mouse movement, and a joystick handle. In particular embodiments, the computer peripheral device further comprises a stabilization member for releasably securing the convertible device to a surface. Advantageously, a trigger button is housed within the joystick handle.

### BRIEF DESCRIPTION OF THE DRAWINGS

The preferred embodiments of a convertible mouse will now be discussed in detail. These embodiments depict the novel and non-obvious convertible mouse in the accompanying drawings, which are for illustrative purposes only. These drawings include the following figures, in which like numerals indicate like parts.

FIG. 1 illustrates a top plan view of a convertible mouse that can be used as a computer mouse and as a joystick.

FIG. 2 illustrates a bottom view of the convertible mouse of FIG. 1.

FIG. 3 illustrates a side view of the convertible mouse of FIG. 1 with the joystick release button housed within and protruding out of the bottom mouse portion.

FIG. 4 illustrates an isometric view of the convertible mouse of FIG. 3.

FIG. 5 illustrates a top view of the convertible mouse illustrated in FIG. 4 after the joystick release button has been activated by the user.

FIGS. 6A-6D illustrate the convertible mouse after the joystick handle has been rotated to an upright position.

FIG. 7 illustrates the convertible mouse in joystick mode with the joystick handle in an upright position and the top joystick buttons in position so that a user can rest his or her thumb on the top joystick buttons.

FIG. 8 illustrates the convertible mouse of FIG. 7 after the joystick handle has been heightened so that a user can comfortably grasp the joystick handle.

FIG. 9 illustrates the convertible mouse illustrated in FIG. 8 secured to a surface with a right stabilization member and a left stabilization member.

FIG. 10 illustrates a process used to make the convertible mouse operational in mouse mode or joystick mode.

### DETAILED DESCRIPTION OF THE PREFERRED EMBODIMENTS

Embodiments of the present invention are described in detail below with reference to the figures, wherein like elements are referenced with like numerals throughout.

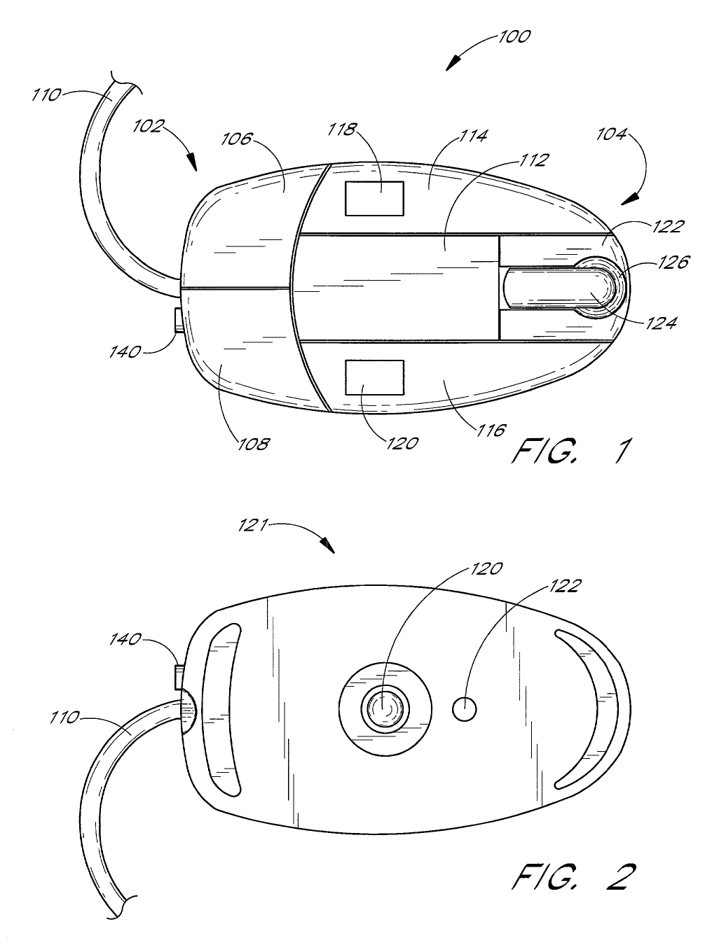

FIG. 1 illustrates a top plan view of a convertible mouse 100 that can be used as a computer mouse and as a computer joystick. The convertible mouse 100 can be transformed from a computer mouse mode to a joystick mode and vice versa. As shown, the convertible mouse 100 is in computer mouse mode. While in the computer mouse mode, the convertible mouse 100 operates in the same manner as a conventional computer mouse. In computer mouse mode, the convertible mouse has a front mouse portion 102 and a rear mouse portion 104. The front mouse portion 102 has disposed therein a right mouse button 106 and a left mouse button 108 that can be used to input data to a computer through a cable 110. In addition, the front mouse portion 102 preferably has disposed therein a joystick release button 140 for transforming modes of the convertible mouse 100. In one embodiment, the front mouse portion 102 has disposed therein one mouse button. In yet another embodiment, the front mouse portion 102 has two or more mouse buttons. The rear mouse portion 104 provides a surface for a user to rest his or her palm on in order to maneuver the convertible mouse 100. The user can then place his or her fingers on the front mouse portion 102 in order to operate the right mouse button 106 and the left mouse button 108.

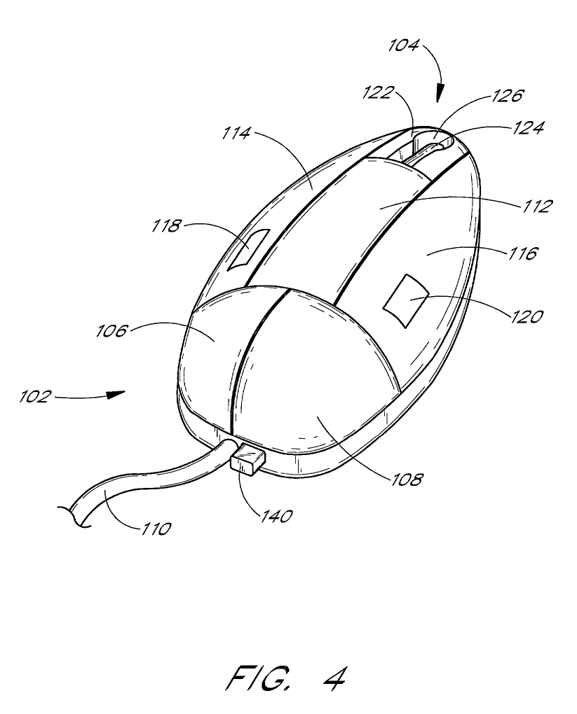

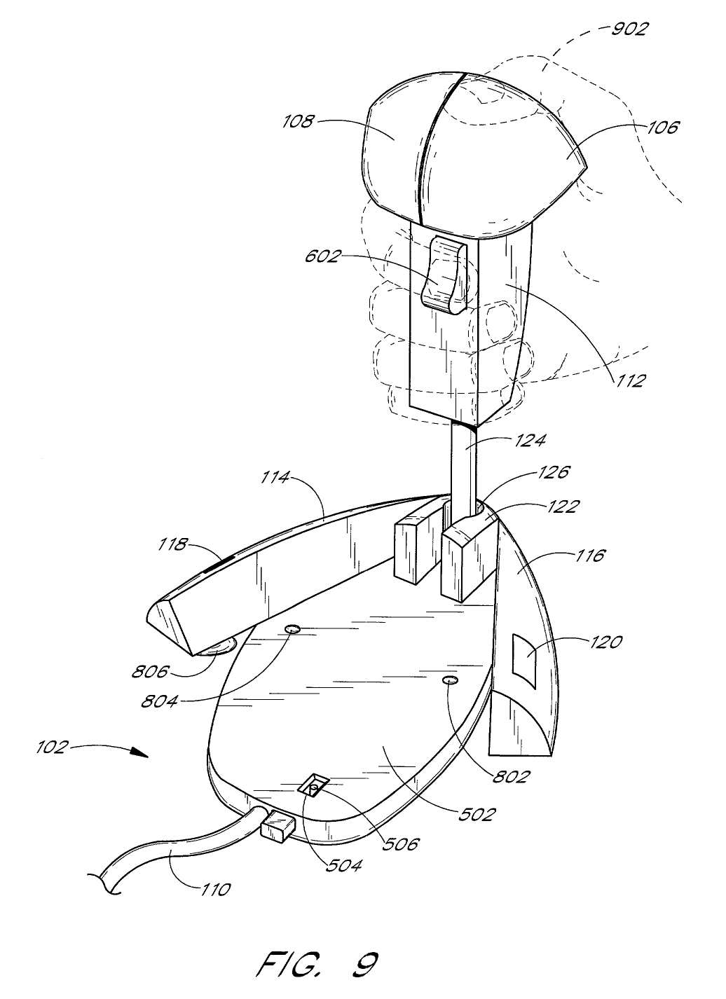

The convertible mouse 100 has a joystick handle 112, a right stabilization member 114, and a left stabilization member 116. As will be discussed in FIGS. 3-9, the joystick handle 112 rotates when the convertible mouse 100 switches from computer mouse mode to computer joystick mode. Further, the right stabilization member 114 and the left stabilization member 116 preferably rotate in order to facilitate the convertible mouse 100 adhering to a surface in joystick mode. A right stabilization member release button 118 can be pressed by the user in order to eject an adhesive device, such as, for example, a suction cup, that facilitates the right stabilization member 114 adhering to a surface. Similarly, a left stabilization member release button 120 can be pressed by the user in order to eject an adhesive device that facilitates the stabilization member 116 adhering to a surface. The mechanics of the right stabilization member release button 118 and the left stabilization member release button 120 will be discussed in more detail with respect to FIG. 9.

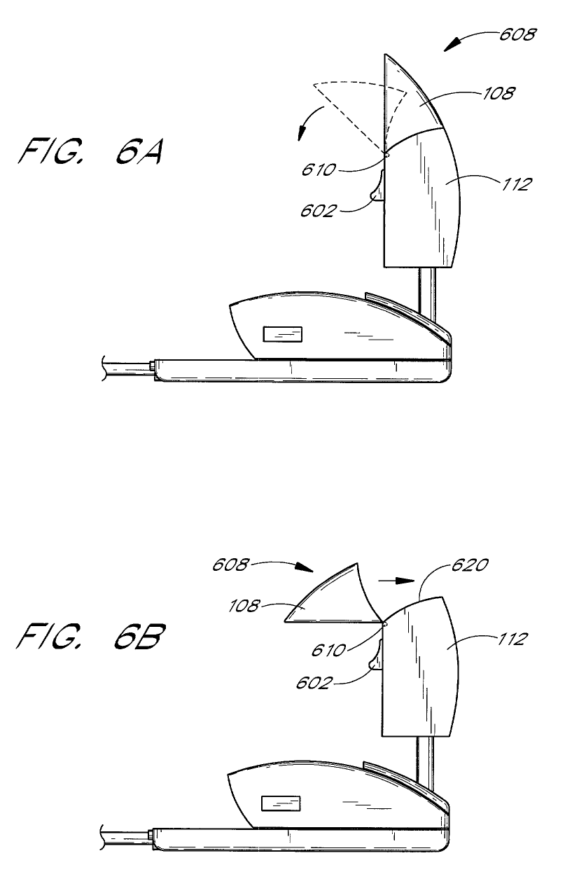

The joystick handle 112 is attached to a joystick rod 124 which lies within a rear mouse portion recess 126 of a base portion 122 located at or near the rear end of the rear mouse portion 104. The joystick rod 124 is attached to the bottom portion of the rear mouse portion recess 126. The mechanics of how the joystick handle 112 is preferably attached to the joystick rod 124, and partially disengages from the rear mouse portion 104 will be discussed with respect to FIGS. 5-9. While in joystick mode, the convertible mouse 100 can be attached to a computer or a gaming console for use in playing video games. Some computer programs allow a user to use a joystick or a mouse to play a video game. The convertible mouse 100 can be used in either joystick mode or mouse mode for these types of computer programs. Most video game users will find that operating in joystick mode provides more maneuverability and reduces the need to use the keyboard during video game play. Some video games will not cooperate with a mouse and will only cooperate with a joystick. Advantageously, the convertible mouse 100 can be used in joystick mode to cooperate with computer programs that only allow for video game play with a joystick. Typical gaming consoles include gaming consoles produced by SONY, SEGA, Nintendo, and Microsoft. Advantageously, even if the convertible mouse 100 will not operate in mouse mode with a gaming console, the convertible mouse 100 can be used in joystick mode. Therefore, a user can unplug the convertible mouse 100 used in mouse mode or joystick mode from a computer and plug it into a gaming console for use in joystick mode. The user can avoid having to buy an expensive joystick for the gaming console by using the convertible mouse 100 in joystick mode. Advantageously, the convertible mouse 100 can be used like a conventional mouse in mouse mode and like a conventional joystick in joystick mode. Therefore, a user of the convertible mouse 100 is not required to adapt his or her game play or navigation of computer equipment to use the convertible mouse 100.

The convertible mouse 100 is particularly advantageous over conventional computer peripheral devices because it combines the functionality of two devices into one device. Computer users can use one port as opposed to two ports in their computers, thereby providing more open ports for use with other devices. Computer users are usually concerned about space and attempt to take up as little space as possible given that a PC is somewhat clunky and takes up a large amount of space. Therefore, the convertible mouse 100 allows the user to take up less space by having one convertible mouse 100 as opposed to two devices. In this embodiment, the convertible mouse 100 advantageously can be transported with one cable as opposed the two cables that would ordinarily be required to transport a mouse and a joystick.

Further, the convertible mouse 100 is particularly advantageous for video game play by multiple players. Many times, video game players have a favorite joystick that they like to use. The hand positions and button configurations vary from joystick to joystick. The convertible mouse 100 provides video game players with a convenient way of transporting their favorite joystick to a friend's house in order to play video games together. A joystick is simply too cumbersome for a user to carry around. A conventional joystick is somewhat clunky with portions of the joystick such as, for example, the handle, that protrude too much to be placed in a conventional small bag. If a user wants to travel to a remote location from his or her home to only use the convertible mouse 100 in joystick mode, the convertible mouse 100 is advantageous because it allows the user to carry the joystick in a compact fashion when the convertible mouse 100 is in mouse mode.

A major drawback to computer users participating jointly in a computer program is that a PC generally has only one mouse. It is simply not convenient for a user to take a mouse and a joystick to a friend's house. The convertible mouse 100 provides more incentive for a user to participate jointly in computer programs. If a user is already going to bring a joystick to a friend's home, the user will have the convertible mouse 100 to operate in mouse mode as well. The convertible mouse 100 can be used by a computer user in conjunction with another computer user to perform joint functions such as pointing to different parts of a document with multiple mouse pointers to have a more meaningful discussion. In addition, joint users can use convertible mice 100 to access the Internet to play multiple player internet games, engage in multi-user browsing sessions on the internet, and participate in multi-user internet activities such as class projects or seminars, etc.

In one embodiment, the convertible mouse 100 is a wireless device and does not require the cable 110 to input data to a computer. In this embodiment, the convertible mouse 100 advantageously can be transported without the two cables that would ordinarily be required to transport both a mouse and a joystick. In mouse mode, the wireless convertible mouse 100 can be placed on different surfaces at a variety of locations in a room with a computer. In joystick mode, the wireless convertible mouse 100 can be placed on a surface or even in a user's palm so that the wireless convertible mouse 100 can be used to play a computer game at almost any location within the vicinity of a computer. In one embodiment, the wireless convertible mouse 100 in joystick mode can be operated by a user as the user is moving across the room. Too often video game players feel constrained by having to sit down and stay within close proximity to a computer while playing a video game. The wireless convertible mouse 100 allows users to become more involved in the video game by allowing users to move from a static position as the game is played.

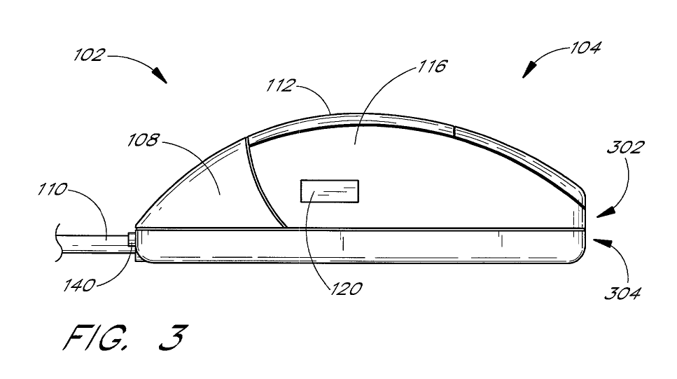

FIG. 2 illustrates a bottom view of the convertible mouse 100 illustrated in FIG. 1. A tracking sensor 130 is positioned on a bottom surface 121 of the convertible mouse 100. A bottom surface hole 122 is fitted to receive a connecting means such as, for example, a screw or bolt, to connect a top mouse portion 302 (FIG. 3) to a bottom mouse portion 304 (FIG. 3). The tracking sensor 130 illustrated in FIG. 2 determines the position of the convertible mouse 100 in mouse mode and transmits the respective coordinates through an electrical signal in the cable 110 to a microprocessor in the computer. The microprocessor uses a software module to calculate the difference in position that the convertible mouse 100 has been moved. The microprocessor then uses a software module to translate the difference in position that the convertible mouse 100 has moved along the surface on which it rests to a difference in the position of the mouse pointer on the computer screen. The microprocessor then works in conjunction with other components of the computer to move the mouse pointer to the new location on the computer screen. One of ordinary skill in the art will recognize that there are a variety of well known methods for transmitting and interpreting electrical signals emanating from a computer mouse.

In one embodiment, the tracking sensor 130 is a conventional track ball housed within the bottom surface 121. In another embodiment, the tracking sensor 130 is an infrared sensor. In yet another embodiment, the tracking sensor 130 is an optical sensor. Any sensor that is recognized in the art for interpreting movement of the convertible mouse 100 in mouse mode can be used as the tracking sensor 130.

The operation of a computer mouse and a joystick are relatively well known in the art. A computer mouse has a microprocessor that transmits signals to a microprocessor in a computer in response to a sensor detecting pressure applied to a mouse button or a sensor detecting movement of the mouse. The computer has a software module which processes the data it receives and displays the processed data on a graphical display. A computer joystick operates in a similar fashion except that a sensor determines movement of the joystick rather than movement of the mouse. In one embodiment, the convertible mouse 100 has one sensor for determining mouse movement and one sensor for determining joystick movement. In another embodiment, the convertible mouse 100 has one sensor for determining both mouse movement and joystick movement. In addition, the convertible mouse can have separate microprocessors or one microprocessor for processing signals in computer mouse mode and joystick mode. One of ordinary skill in the art will be familiar with the electrical layout of a computer mouse and a computer joystick. Therefore, the electrical layout of the computer mouse and the computer joystick will not be described in further detail.

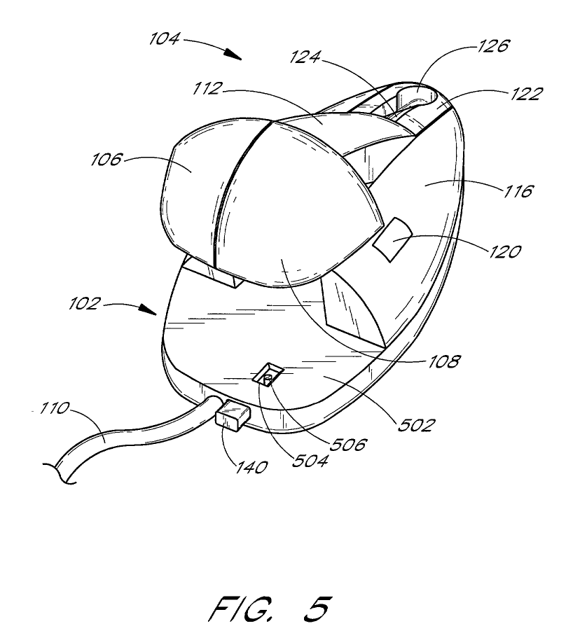

FIGS. 3 and 4 illustrate perspective views of the convertible mouse 100 with the joystick release button 140 with which a user can press to change the convertible mouse 100 from mouse mode to joystick mode. FIG. 3 illustrates a side view of the convertible mouse 100 illustrated in FIG. 1 with the joystick release button 140 housed within and protruding out of the bottom mouse portion 304. When the user presses the joystick release button 140, the joystick handle 112, the right mouse button 106 (FIG. 4), and the left mouse button 108 are prodded off the bottom mouse portion 304 so that the user can grasp the joystick handle 112 and rotate the joystick handle 112 into an upright position.

One of ordinary skill in the art will recognize a number of well known button mechanisms that can be used as the joystick release button 140 illustrated in FIG. 3. The bottom mouse portion 304 in the front mouse portion 102 generally does not have much circuitry or mechanical parts housed within it. Rather, the majority of circuitry and mechanical parts are generally located in the rear mouse portion 104. Therefore, one skilled in the art should find a sufficient amount of space located within the bottom mouse portion 304 in the front mouse portion 102 for a well known button mechanism that can be used as the joystick release button 140. In one embodiment, the housed portion (not shown) of the joystick release button 140 is a spring loaded rod that has a downwardly sloping tip at the end of the spring loaded rod facing the rear mouse portion 304. A vertically mounted prodding member 506 (FIG. 5) has a downwardly sloping tip that engages the floor of the bottom mouse portion 304. When the user presses the joystick release button 140, the downwardly sloping tip of the joystick release button 140 pushes against the upwardly sloping tip of the vertically mounted prodding member 506. As a result, the vertically mounted prodding member is disengaged from the floor of the bottom mouse portion 304 and is pushed up through a window 504 against the bottom of the left mouse button 108. In one embodiment, the window 504 rests under the right button 106, and the vertically mounted prodding member is pushed up through the window 504 against the bottom of the right mouse button 106. The user can then grasp the joystick handle 112. The spring is tensioned to force the joystick release button 140 back to its original position. The top portion of the vertically mounted prodding member then falls back down through the window 504.

An electronic sensor (not shown) is positioned on the top portion of the bottom surface 502 to alert the microprocessor when the convertible mouse 100 is being transformed from mouse mode to joystick mode. The electronic sensor can be positioned anywhere on the top portion of the bottom surface 502. In one embodiment, the electronic sensor detects when pressure is no longer exerted on the top portion of the bottom surface 502 and alerts the microprocessor that the convertible mouse 100 is being transformed from mouse mode to joystick mode. In another embodiment, the electronic sensor is electronically coupled to the joystick release button 140 so that the microprocessors alerted when the joystick release button 140 is activated.

As illustrated in FIG. 4, the friction of the right stabilization member 114 and the left stabilization member 116 with the joystick handle 112 hold the joystick handle 112 in place. In one embodiment, the user rotate the right mouse button 106 and the left mouse button 108 backward without pressing the joystick release button 140 in order to change the convertible mouse 100 from mouse mode to joystick mode. The user can place the convertible mouse 100 on a surface and grasp the right mouse button 106 or the left mouse button 108 to rotate the right mouse button 106 and the left mouse button 108 off the top portion of the bottom surface 502 (FIG. 5). Similarly, the user can grasp the bottom mouse portion 304 with one hand and grasp the right mouse button 106 and the left mouse button 108 with the other hand to rotate the right mouse button 106 and the left mouse button 108 backward. One of ordinary skill in the art will recognize a number of ways that a user can grasp the right mouse button 106 or the left mouse button 108 to convert the convertible mouse 100 from mouse mode to joystick mode or vice versa.

The electronic sensor that is positioned on the top surface of the bottom portion 502 is also configured to alert the microprocessor when the convertible mouse 100 switches to mouse mode. One of ordinary skill in the art will recognize a number of different sensors which can operate in this fashion. One exemplary sensor would alert the microprocessor when pressure is exerted on the top portion of the bottom surface 502 (FIG. 5) that the convertible mouse is in mouse mode. When the joystick handle 112 is lifted, the sensor would alert the microprocessor that the convertible mouse is in joystick mode because pressure is no longer exerted on the top portion of the bottom surface 502.

The joystick handle 112, the left mouse button 106, or the right mouse button 108 illustrated in FIG. 4 can also be configured to be latched down to a top portion of the bottom surface 502 (FIG. 5). In another embodiment, the joystick release button 140 is spring loaded and has an upwardly sloping tip that makes contact with a tab that is vertically attached to the ceiling of the top portion of the bottom surface 502 (FIG. 5). The tab is hinged to the ceiling so that the tab can rotate as the joystick release button 140 engages the tab. The tab is connected to a latch which rests on the top portion of the bottom surface 502. The latch hooks onto a mating latch on the bottom surface of the left mouse button 108, or alternatively on the bottom surface of the right mouse button 106. When the user presses the joystick release button 140, the latch unhooks, and the user can lift the joystick handle 112. The user then presses the joystick release button 140, pushes down on the joystick handle 112, and releases the joystick release button 140 to re-latch the joystick handle 112.

In yet another embodiment, the joystick release button 140 lies vertically in the top mouse portion 302 (FIG. 3) between the right mouse button 106 and the left mouse button 108. As the user presses down on the joystick release button, the bottom of the joystick release button is prodded against the top portion of the bottom surface 502 (FIG. 5), thereby exerting an upward force to disengage the joystick handle 112 from the top portion of the bottom surface 502.

One of ordinary skill in the art will recognize that the joystick release button 140 can be placed virtually anywhere on the convertible mouse 100. In one embodiment, the joystick release button 140 is an external lever positioned on the rear mouse portion 104. The user presses the joystick release button 140 which prods the joystick handle 112 off of a latch. In yet another embodiment, the joystick release button 140 is a latch placed on the rear mouse portion 104 that allows the user to grasp the joystick handle 112 after the latch is unlatched. Regardless of the amount of circuitry within the rear mouse portion 104, an external mechanism recognized by one skill in the art can be used as the joystick release button 140 to avoid interfering the internal circuitry.

In another embodiment, the joystick release button 140 is a wheel connected to a latch that lies vertically in the top mouse portion 302 (FIG. 3) between the right mouse button 106 and the left mouse button 108. As the user rolls the joystick release button 140 in one direction, the latch attached to the joystick release button unhooks from a latch attached to the top portion of the bottom surface 502.

In yet another embodiment, the joystick release button 140 cooperates with a spring located in the joystick handle 112. When the user presses the joystick release button 112, the joystick handle 112 automatically is elevated to an upright position without the user having pull the joystick handle 112 to the upright position. Similarly, when the user presses the joystick release button 140, the joystick handle 112 automatically returns to engaging the top portion of the bottom surface 502 (FIG. 5).

In any of the embodiments discussed above, the joystick release button 140 illustrated in FIG. 3 can advantageously be placed in the front mouse portion 102 in a variety of positions because of the sufficiency of space located in the front mouse portion 102. The joystick release button 140 can be positioned along the side or anywhere around the periphery of the bottom mouse portion 304 in the front mouse portion 102.

FIG. 4 illustrates a top view of the convertible mouse 100 with the joystick release button 140. After the joystick release button is activated, the joystick handle 112 is elevated above the recess between the right stabilization member 114 and the left stabilization member 116. The user can then grasp the joystick handle 112. The joystick handle 112 is attached to the joystick rod 124 which is attached to a hinge located within the rear mouse portion recess 126 in the base portion 122. As the user rotates the joystick handle 112 upward, the joystick rod 124 rotates about the hinge.

FIG. 5 illustrates a top view of the convertible mouse illustrated in FIG. 4 after the joystick release button 140 has been activated by the user. As can be seen, the joystick handle 112 is elevated above the recess between the right stabilization member 114 (FIG. 4) and the left stabilization member 116.

The joystick handle 112, once elevated from the recess, can be rotated backward because the joystick rod 124 is attached to the hinge located within the rear mouse portion recess 126. The sides of the base portion 122 prevent the joystick handle 112 from moving side to side as the joystick handle 112 is being grasped by the user in order to pull the joystick handle 112 back into in an upright position. Once the joystick handle 112 is locked into an upright position, it locks into engagement with a ball (not shown) located within the rear mouse portion recess 126. In the upright position, the joystick handle 112 can move in any direction and rotate in circular motions as well.

In one embodiment, a ball and socket configuration is used in place of a hinge. The end of the joystick rod 124 lying within the rear mouse portion recess 126 is in the shape of a sphere. The end of the joystick rod 124 lies within a groove within the rear mouse portion recess 126 in which it can slide. As the joystick handle 112 is grasped by the user, the end of the joystick rod 124 slides into a circular recess at the bottom of the rear mouse portion recess 126. The joystick handle 112 can now move in any direction and can rotate in circular motions as well.

One of ordinary skill in the art will recognize a number of mechanisms for locking the joystick handle 112 into place and providing for multi-functional and rotational movement after the joystick handle 112 has been locked into position. The convertible mouse 100 advantageously provides for the joystick handle 112 to have better maneuverability than an average joystick handle which may not have rotational capabilities. Although many multi-functional devices sold on the market today achieve multi-functionality with diminishing functionality for each function, the convertible mouse 100 can operate as a top caliber computer mouse in mouse mode and a top caliber joystick in joystick mode.

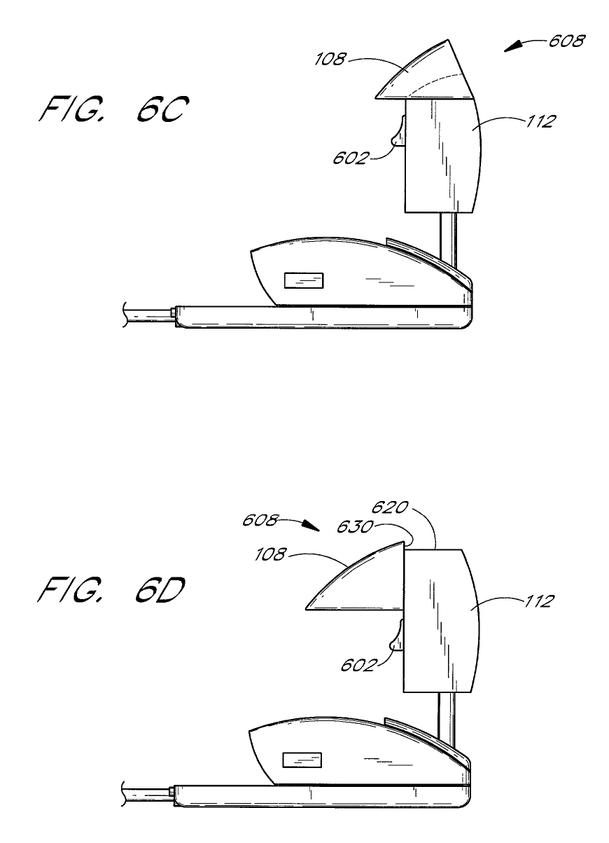

FIGS. 6A-6D illustrate the convertible mouse 100 after the joystick handle 112 has been locked into an upright position. The user can use the right mouse button 106 (FIG. 5) and the left mouse button 108 as top joystick buttons 608 illustrated in FIG. 6A. Because the top joystick buttons 608 were used as the right mouse button 106 and the left mouse button 108 while the convertible mouse 100 was in mouse mode, the top joystick buttons stand vertically on top of the joystick handle 112. For the user to access the top joystick buttons 608, the user should be able to rest his or her thumb horizontally across the joystick buttons 608. As illustrated in FIGS. 6A and 6B, in one embodiment, the user can press downwards on the top joystick buttons 608 and rotate the top joystick buttons 608 about a hinge 610. A person with large hands will be well suited for this embodiment because he or she can relax his or her hands and comfortably press the top joystick buttons 608 without having to bend his or her fingers too much. One of ordinary skill in the art will recognize a number of pivots or hinges and locking mechanisms that can be used to rotate the top joystick buttons 608 and lock the top joystick buttons 608 into a horizontal position.

FIG. 6C illustrates an alternate embodiment where the top joystick buttons 608 are positioned directly above the joystick handle 112. One of ordinary skill in the art will recognize a number of mechanisms for this configuration. For example, the top joystick buttons 608 illustrated in FIG. 6A can have an internal rod. The top joystick buttons 608 are pulled up along the internal rod and swing along a hinge until the top joystick buttons 608 rest directly on top of the joystick handle 112. A person with small hands can comfortably reach the top joystick buttons in this embodiment.

FIG. 6D illustrates an alternate embodiment where the top joystick buttons rest horizontally. The rear portion 630 of the top joystick buttons 608 lie vertically against the top vertical portion of the joystick handle 112. One of ordinary skill in the art will recognize a number of configurations for sliding the top joystick buttons 608 down the top vertical portion of the joystick handle 112 and locking the top joystick buttons into position. For example, the top joystick buttons 630 can have grooves that mate with protrusions within the joystick handle 112 to allow the top joystick buttons to slide down from the top of the joystick handle 112.

FIGS. 6A through 6D also illustrate a trigger button 602 that is housed within the joystick handle 112 when the convertible mouse 100 is in mouse mode. After the joystick release button 140 (FIG. 5) is pressed and the joystick handle 112 is elevated, the trigger button housed within a recess (not shown) in the joystick handle 112 is released. The trigger button 602 operates as a conventional trigger button on a joystick in cooperation with a computer program such as, for example, a video game. One of ordinary skill in the art will recognize that additional buttons to be used as trigger buttons, motion buttons, or other gaming buttons known in the art can be placed along the joystick handle 112 or on the right stabilization member 114 or the left stabilization member 116.

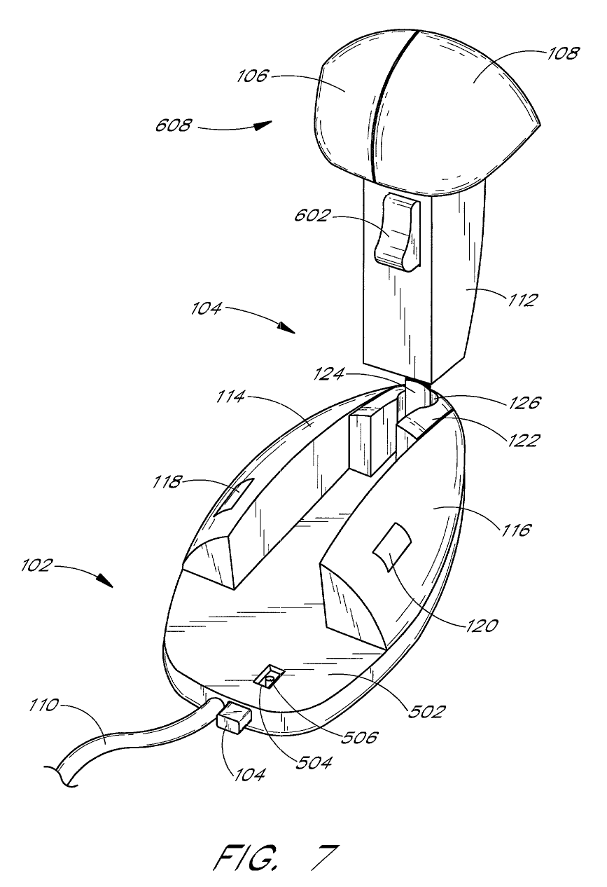

FIG. 7 illustrates the convertible mouse 100 in joystick mode with the joystick handle 112 in an upright position and the top joystick buttons 608 in position so that a user can rest his or her thumbs on the top joystick buttons 608. For most users' hands, the joystick handle 112 will not be long enough to maneuver the joystick handle 112. In one embodiment, the joystick handle 112 can slide upwards on the joystick rod 124 and lock into a more comfortable position. In another embodiment, the joystick handle slides up the joystick rod 124 and can lock into position at different heights to adapt to different users' hand sizes. One of ordinary skill in the art will recognize a number of locking and ratcheting mechanisms for adjusting the height of the joystick handle 112.

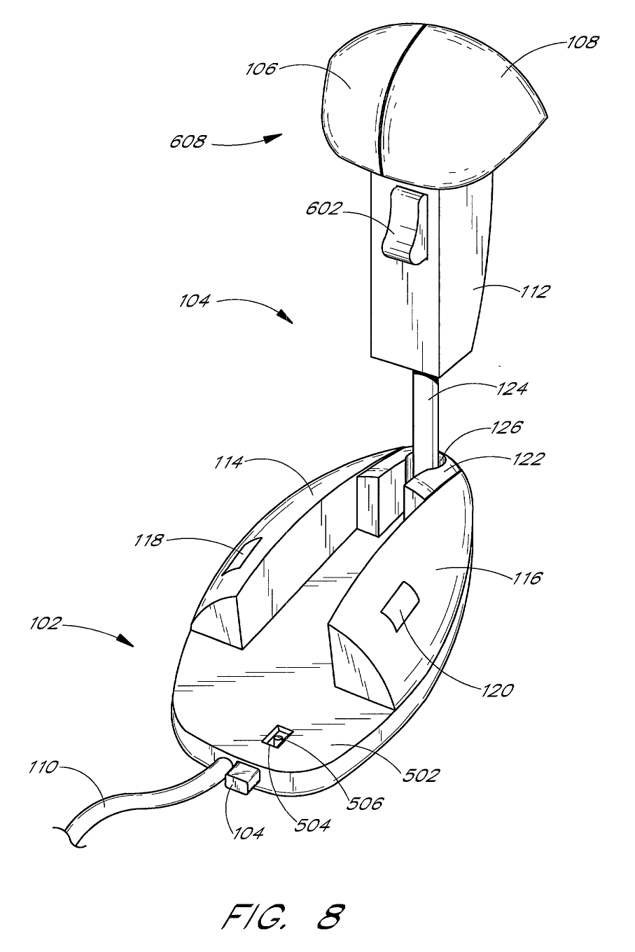

FIG. 8 illustrates the convertible mouse illustrated in FIG. 7 after the joystick handle 112 has been heightened so that a user can comfortably grasp the joystick handle 112. The convertible mouse 100 is in joystick mode and is fully functional as a joystick. The joystick rod 124 advantageously sits within a rear mouse portion recess 126 to allow for the joystick handle 112 to move in all directions and to rotate in circular motions.

FIG. 9 illustrates the convertible mouse 100 illustrated in FIG. 8 secured to a surface with the right stabilization member 114 and the left stabilization member 116. The user can grasp the joystick handle with his or her hand 902. The hand 902 is operably positioned to use the convertible mouse 100 in joystick mode. The user can support the convertible mouse 100 in the palm of his or her other hand. The user can also adhere the convertible mouse 100 to a surface to advantageously free up one hand. The user can rotate the right stabilization member 114 and the left stabilization member 116 to facilitate securing the convertible mouse 100 to a surface. In one embodiment, the right stabilization member 114 has a ball bearing (not shown) on the bottom of the right stabilization member 114 to mate with a right ball bearing hole 804. The ball bearing mating with the right ball bearing hole 804 prevents movement of the right stabilization member in mouse mode or in joystick mode if the user does not wish to use the right stabilization member. If the user would like to secure the convertible mouse 100 in joystick mode to a surface, the user lifts the right stabilization member 114 slightly above the top portion of the bottom surface 502 to remove the ball bearing from the right ball bearing hole 804. The user then slides the right stabilization member 114 out to the side past the top portion of the bottom surface 502. The portion of the right stabilization member 114 closest to the base portion 122 is attached to a pivot or a hinge at the base portion 122 to allow the right stabilization member 114 to pivot outward. The left stabilization member 116 works in the same manner with respect to the left ball bearing hole 802. In another embodiment, the left ball bearing hole 802 and the right ball bearing hole 804 are positioned along periphery of the top portion of the bottom surface 502. In another embodiment, magnets are attached to the bottom of the right stabilization member 114 and the left stabilization member 116 to cooperate with magnets on the top portion of the bottom surface 502.

In another embodiment, the ball bearings positioned within the right stabilization member 114 and the left stabilization member 116 are spring loaded. The user can slide the right stabilization member 114 and the left stabilization member 116 to the sides without lifting the right stabilization member 114 or the left stabilization member 116. The ball bearings are spring loaded so that the ball bearings withdraw into recesses housed within the right stabilization member 114 and the left stabilization member 116 as the user pushes the right stabilization member 114 and the left stabilization member 116 to the sides.

In yet another embodiment, the left ball bearing hole 802 and the right ball bearing hole 804 can be ball bearings that mate with hollow hubs positioned along the bottom portions of the right stabilization member 114 and the left stabilization member 116. One of ordinary skill in the art will recognize a number of ways for moving the right stabilization member 114 and the left stabilization member 116 off the top portion of the bottom surface 502.

After the right stabilization member 114 and the left stabilization member 116 have been moved outwardly away from the top portion of the bottom surface 502, the right stabilization member release button 118 can be pressed to eject a right suction cup 806 to adhere to a surface, and the left stabilization member release button 120 can also be pressed to eject a left suction cup (not shown) to adhere to a surface. A variety of surfaces can be used, such as, for example, a table, a desk, a top of a keyboard, etc. The right stabilization member release button 118 and the left stabilization member release button 120 are preferably spring loaded to eject the right suction cup 806 and the left suction cup. In one embodiment, magnets are used to adhere to a magnetic surface. In another embodiment, VELCRO® is attached to the bottom of the right stabilization member 114 and the left stabilization member 116 to cooperate with corresponding VELCRO® on the top portion of the bottom surface 502.

In one embodiment, the right stabilization member 114 and the left stabilization member 116 are capable of pivoting outwardly at right angles with respect to the top portion of the bottom surface 502. When placed at rights angles, the right stabilization member 114 and the left stabilization member 116 provide the greatest amount of stability for the convertible mouse 100 in joystick mode.

In yet another embodiment, the right stabilization member 114 and the left stabilization member 116 do not need to move outwardly away from the top portion of the bottom surface 502 because at least a portion of the convertible mouse 100 has a groove that mates with at least one protrusion on a side of a keyboard (not shown). The at least one protrusion can be positioned on or around the periphery of the keyboard. The convertible mouse 100 can slide on to the protrusion in order to be securely positioned. The user can remove the convertible mouse 100 by sliding it off of the protrusion. In another embodiment, the convertible mouse 100 can have at least one protrusion on the side of the convertible mouse 100 that mates with at least one groove located on a side of the keyboard. Similarly, the at least one protrusion can be positioned on or around the periphery of the keyboard. The convertible mouse 100 can engage other computer peripheral devices in a similar fashion in order to secure the convertible mouse 100. In yet another embodiment, the convertible mouse 100 can have a ball bearing that mates with a recess in a separate computer peripheral device (not shown) to secure the convertible mouse 100. In another embodiment, the convertible mouse 100 can have a recess which mates with a ball bearing positioned on a separate computer peripheral device (not shown). The convertible mouse 100 can be held in place by any number of ways recognized by one of ordinary skill in the art.

The convertible mouse 100 can be transformed from joystick mode back to mouse mode by performing the steps outlined above in the reverse order. The right stabilization member 114 and the left stabilization member 116 can be pivoted back on to the top portion of the bottom surface 502. The top mouse buttons 608 are flipped upward about the hinge 610. The height of the joystick handle 112 is reduced, and the joystick handle 112 is unlocked so that it can be fitted in to the recess between the right stabilization member 114 and the left stabilization member 116. In one embodiment, the joystick release button 140 is only needed to prod the joystick handle 112 upward off the top portion of the bottom surface 502 and does not have to be pressed before the joystick handle 112 re-engages the top portion of the bottom surface 502. In another embodiment, the joystick release button 140 needs to be pressed before the joystick handle 112 re-engages the top portion of the bottom surface 502 so that the joystick handle 112 can re-latch a latching mechanism positioned on the top portion of the bottom surface 502.

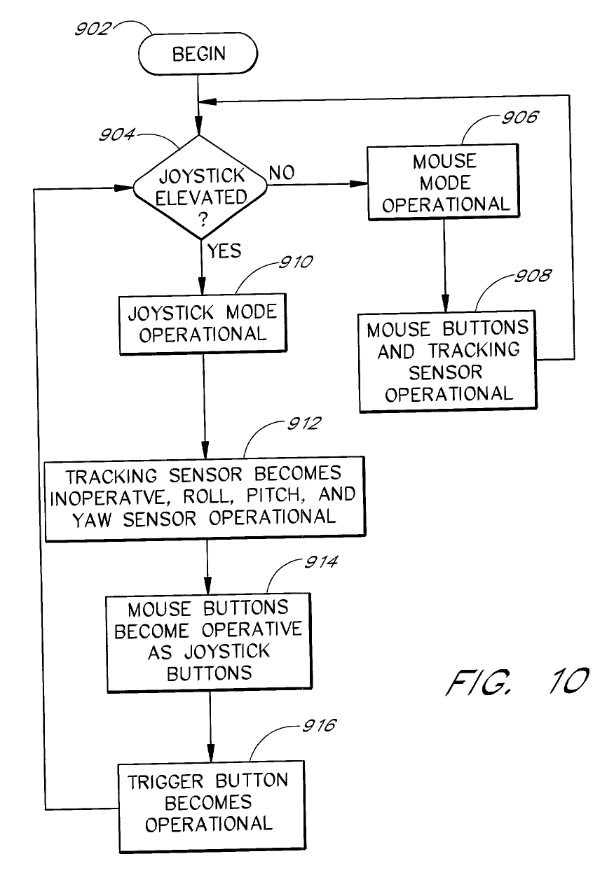

FIG. 10 illustrates a process used to make the convertible mouse 100 operational in mouse mode or joystick mode. The process begins at a process block 902. The process advances to a decision block 904, where a sensor determines if the joystick handle 112 (FIG. 5) has been disengaged from the top portion of the bottom surface 502 (FIG. 5). If as seen in FIG. 4, the right mouse button 106, the left mouse button 108, and the joystick handle 112 are not disengaged from the top portion of the bottom surface 502, then the process advances to a process block 906. At the process block 906, the mouse mode is operational. The process advances to the process block 908, where the right mouse button 106 (FIG. 1), the left mouse button 108 (FIG. 1), and the tracking sensor 130 (FIG. 2) become operational for use in computer mouse mode. The process then advances to the decision block 904 to determine if the user has lifted the joystick handle 112 (FIG. 4). If the user has not lifted the joystick handle 112, the convertible mouse 100 remains in mouse mode.

If the user has lifted the joystick handle 112, the process advances to a process block 910, where the joystick mode becomes operational. The joystick handle 112 is now used as a joystick handle as opposed to a resting location for the palm of the user. The process advances to a process block 912 where the tracking sensor 130 (FIG. 2) of the convertible mouse 100 becomes inactive. The convertible mouse in joystick mode does not need to transmit data to the microprocessor relating to the position of the device. Rather, data involving the movement of the joystick handle 112 in relation to the rest of the convertible mouse is transmitted to the microprocessor. A roll, pitch, and yaw sensor deciphers the movement of the joystick handle 112 when activated. The process then advances to a process block 914 where the right mouse button 106 and the left mouse button 108 become activated as joystick buttons. The right mouse button 106 and the left mouse button 108 can be used as firing buttons, motion buttons, or any other type of joystick button known to one skilled in the art. Finally, the process advances to a process block 916 where the trigger button 602 is activated for use as a trigger button in joystick mode. One of ordinary skill in the art will recognize that the sequence of activating and deactivating the various buttons and sensors when transforming to joystick mode can be done in any order. For instance, the trigger button can be activated before the right mouse button 106 and the left mouse button 108 are activated.

The various embodiments of the convertible mouse 100 described herein address and solve the problems associated with conventional computer peripheral devices. The convertible mouse 100 described herein eliminates the portability problem of transporting both a mouse and a joystick. One compact device can be transported with a laptop or to a remote location to be used with another PC. Even if the user would only like to use the convertible mouse 100 in joystick mode, the convertible mouse 100 is more compact than carrying a clunky joystick.

### Scope of the Invention

The above presents a description of the best mode contemplated for the present convertible mouse, and of the manner and process of using it, in such full, clear, concise and exact terms as to enable any person skilled in the art to which it pertains to use this convertible mouse. This convertible mouse is, however, susceptible to modifications and alternate constructions from that discussed above which are fully equivalent. Consequently, it is not the intention to limit this convertible mouse to the particular embodiments disclosed. On the contrary, the intention is to cover all modifications and alternate methods of operation coming within the spirit and scope of the convertible mouse as generally expressed by the following claims, which particularly point out and distinctly claim the subject matter of the convertible mouse.

What is claimed is:

1. A convertible mouse for use as a computer mouse and as a joystick, the convertible mouse comprising:
a computer mouse, the computer mouse having a recess positioned in a portion of the convertible mouse, the computer mouse having a sensor for deciphering mouse movement;
a joystick handle housed within the recess, the joystick handle attached to a connecting member which is attached to the computer mouse, the joystick handle operably positioned within the recess so that the joystick handle can be elevated from the recess; and
a joystick release button attached to the computer mouse, the joystick release button permitting elevation of the joystick handle from the recess.

2. The convertible mouse of claim 1, further comprising at least one stabilization member for releasably securing the convertible mouse to a surface.

3. The convertible mouse of claim 2, wherein the at least one stabilization member is housed within the rear portion of the mouse.

4. The convertible mouse of claim 2, wherein a button is positioned on the at least one stabilization member to eject an adhesive device when activated.

5. The convertible mouse of claim 4, wherein the adhesive device is a suction

6. The convertible mouse of claim 1, further comprising at least one joystick button positioned on the joystick handle for cooperation with a computer program.

7. The convertible mouse of claim 6, wherein the at least one joystick button is a trigger button.

8. The convertible mouse of claim 6, wherein the at least one joystick is a button operable with the computer mouse.

9. The convertible mouse of claim 1, wherein a sensor determines if the joystick release button has been activated and transmits data to a microprocessor indicating that the convertible mouse is in a mouse mode or a joystick mode.

10. The convertible mouse of claim 1, wherein the sensor is a mouse trackball.

11. The convertible mouse of claim 1, wherein the sensor is an infrared sensor.

12. The convertible mouse of claim 1, wherein the sensor is an optical sensor.

13. The convertible mouse of claim 1, further comprising a roll, pitch, and yaw sensor for deciphering joystick movement.

14. The convertible mouse of claim 1, wherein the joystick handle varies in length to accommodate different users.

15. The convertible mouse of claim 1, wherein the convertible mouse is wireless.

16. The convertible mouse of claim 1, wherein the convertible mouse has a groove for receiving a protrusion of a separate computer peripheral device to secure the convertible mouse.

17. The convertible mouse of claim 1, wherein the convertible mouse has a protrusion for engaging a groove of a separate computer peripheral device to secure the convertible mouse.

18. A method of transforming a computer peripheral device from a mouse to a joystick comprising:
providing a computer mouse, said mouse having a left button, a right button, and a palm resting surface; and
rotating the left button and the right button from a first position to a second position, thereby exposing a joystick handle.

19. The method of claim 18, further comprising the step of transforming the computer peripheral device from the joystick to the mouse.

20. The method of claim 18, further comprising the step of accessing at least one stabilization member housed in the convertible mouse, the at least one stabilization member being operatively attached to at least one adhesive device.

21. The method of claim 20, further comprising the step of securing the at least one stabilization member to a surface with the use of the at least one adhesive device.

22. The method of claim 18, wherein activation of a joystick release button causes the joystick handle to be positioned so that a user can rotate the left button and the right button.

23. The method of claim 22, wherein activation of the joystick release button disengages a locking mechanism so that a user can position the joystick handle in place for cooperation with a computer.

24. A computer peripheral device, the computer peripheral device comprising:
a left button;
a right button;
a sensor for deciphering mouse movement; and
a joystick handle.

25. The computer peripheral device of claim 24, wherein the sensor for deciphering mouse movement is a mouse trackball.

26. The computer peripheral device of claim 24, wherein the sensor for deciphering mouse movement is an infrared sensor.

27. The computer peripheral device of claim 24, wherein the sensor for deciphering mouse movement is an optical sensor.

28. The computer peripheral device of claim 24, further comprising a stabilization member for releasably securing the convertible mouse to a surface.

29. The computer peripheral device of claim 24, wherein a trigger button is housed within the joystick handle.
